(19) United States
(12) Patent Application Publication
(10) Pub. No.: US 2025/0236307 A1
(43) Pub. Date: Jul. 24, 2025

(54) Method for Assisting During a Coupling Process With a Trailer, Computing Device, and Assistance System for a Vehicle

(71) Applicant: Bayerische Motoren Werke Aktiengesellschaft, Muenchen (DE)

(72) Inventor: Michael STROEBEL, Groebenzell (DE)

(21) Appl. No.: 18/699,339

(22) PCT Filed: Sep. 21, 2022
(86) PCT No.: PCT/EP2022/076179

§ 371 Date: Apr. 8, 2024

(30) Foreign Application Priority Data
Oct. 8, 2021 (EP) 21201633.1

(51) Int. Cl. B60W 50/14; B60W 30/18

(52) U.S. Cl. CPC B60W 50/14; B60W 30/18009; B60W 2540/215; B60W 2554/80

(57) ABSTRACT

A method for assisting an occupant of a vehicle during a coupling process with a trailer, comprising receiving surroundings data from at least one surroundings sensor, detecting parameters of the trailer via the surroundings data, and determining a position of the vehicle via the surroundings data and/or taking into account the parameters of the trailer. The method also comprises detecting a system input from the occupant, describing a request for support for coupling the trailer to the vehicle. Finally, the method comprises planning a trajectory for the vehicle, starting at the starting point and being determined such that a vehicle coupling unit of the vehicle is in a tolerance range around the trailer coupling unit position, after the vehicle is maneuvered along the trajectory. The system input comprises input of a coupling angle and/or a determination of the coupling angle depending on the system input.

### BACKGROUND AND SUMMARY

The present disclosure relates to a method for assisting a driver of a vehicle in a process of coupling the vehicle to a trailer. Furthermore, the present disclosure relates to an assistance system for a vehicle, for assisting a driver of the vehicle in a process of coupling the vehicle to a trailer. Finally, the present disclosure relates to a computing device for an assistance system of a vehicle.

Methods and systems for assisting a driver of a vehicle in a coupling process in which a trailer is coupled to the vehicle have been known for some time. Such systems are often referred to as trailer coupling assistants. In most cases, the trailer coupling of the trailer is sensed via the sensors present on the vehicle, for example an ultrasonic sensor, a camera or the like. The driver may then be assisted in maneuvering the vehicle to a possible coupling position, such that the trailer can then be coupled to the vehicle.

The publication DE 10 2009 045 284 A1 relates to a method for assisting a driver of a motor vehicle in a driving maneuver for coupling an object, that is to be coupled and that has a coupling point, to a towing device of the motor vehicle, in which the object to be coupled is stationary and the motor vehicle is moved toward the object to be coupled, in which the distance and the direction of the coupling point to the towing device of the motor vehicle is first sensed via at least one distance sensor, and the distance and the direction between the coupling point and the towing device is displayed for the driver.

The published patent application DE 10 2010 004 920 A1 relates to a device for assisting the coupling of a trailer to a trailer coupling of a motor vehicle, and to a method for coupling a trailer to a motor vehicle. Means are provided in this case for determining the relative position of a trailer coupling of a trailer in relation to the trailer coupling of the motor vehicle, and for controlling the movement of the motor vehicle and/or a relative movement of the trailer coupling of the motor vehicle in relation to the motor vehicle on the basis of the relative position determined by sensors.

The publication DE 10 2018 202 613 A1 relates to a method for assisting a process of coupling a motor vehicle to a trailer, in which a position of a coupling element on the trailer is recognized by means of a trailer coupling assistant and, based on this, the vehicle is maneuvered at least partially autonomously into a destination position in which a trailer coupling of the motor vehicle is arranged in a predefined coupling position relative to the coupling element on the trailer. During the maneuvering process in this case, a rear monitoring region of the motor vehicle is monitored by means of a parking aid. The parking aid in this case is operated in a standard mode with the trailer coupling assistant deactivated. With the trailer coupling assistant activated, the parking aid is also operated in a coupling mode, in which obstacle warnings relating to the rearward region are emitted by means of the parking aid in a manner different from that in the standard mode.

An object of the present disclosure is to indicate a solution as to how a driver of a vehicle may be assisted, more effectively than with the prior art, during a process of coupling to a trailer.

A method according to the disclosure for assisting a driver of a vehicle in a process of coupling the vehicle to a trailer comprises receiving environment data from at least one environment sensor. Additionally, the method comprises acquiring parameters of the trailer via the environment data, wherein the parameters describe at least a trailer longitudinal axis and a trailer coupling-unit position of a trailer coupling unit of the trailer. Furthermore, the method comprises determining an attitude of the vehicle via the environment data and/or in consideration of the parameters of the trailer, wherein the attitude describes at least one position of the vehicle relative to the trailer coupling-unit position, and a vehicle longitudinal axis relative to the trailer longitudinal axis. The method additionally comprises acquiring a system input from the driver of the vehicle via a human-machine interface, wherein the system input describes a request from the driver for assistance to couple the trailer to the vehicle. Finally, the method comprises planning a trajectory for the vehicle, wherein the trajectory commences at the starting point and is determined by a vehicle coupling unit of the vehicle being in a tolerance range around the trailer coupling-unit position following maneuvering of the vehicle along the trajectory. The system input in this case comprises an explicit input of a coupling angle between the vehicle longitudinal axis and the trailer longitudinal axis, and/or a determination of the coupling angle in dependence on the system input. Moreover, the trajectory is additionally determined by the vehicle longitudinal axis, following maneuvering of the vehicle along the trajectory, being at the coupling angle in relation to the trailer longitudinal axis.

The vehicle may be, for example, a passenger car. Furthermore, the vehicle may also be a truck, a commercial vehicle, a self-propelled work machine, a mobile home, or the like. In particular, the vehicle may also be a tractor, an agricultural or forestry tractor unit, an articulated truck, a bus, or the like.

The trailer may be, for example, a simple passenger-car trailer, which may have both an overrun brake and its own service brake. Furthermore, boat trailers, caravans, horse trailers, semi-trailers, a harvester, or the like are also conceivable. In general, the steering technology of the trailer is irrelevant here. In particular, it may be an unsteered (rigid-axle) trailer. Furthermore, the trailer may also have swivel-axis steering or single-pivot steering.

The term trailer coupling unit and the term vehicle coupling unit, as used in this document, are intended to refer generally to two devices acting mechanically in combination, for example mutually engaging devices, that are configured to connect the vehicle to the trailer. Depending on the type of vehicle and trailer, for example a pin coupling, a jaw coupling, or a fifth-wheel coupling is conceivable, and corresponding coupling parts are intended to be included in the term trailer coupling unit, or the term vehicle coupling unit. In particular, the term trailer coupling unit, or the term vehicle coupling unit, are also to be understood to include the corresponding coupling parts of a ball coupling, i.e., a tow-ball coupling, or a coupling ball, that correspond to the current coupling standard, especially in the passenger car sector, in combination with light trailers (with/without overrun brake).

The term process of coupling as used in this document also includes, in particular, the manual and at least partially automated maneuvering, or positioning, of the vehicle along a trajectory at the end of which the trailer can be coupled to the vehicle.

In the method according to the disclosure, environment data are therefore received from at least one environment sensor. Preferably, the at least one environment sensor is arranged on the vehicle. For example, a camera, a radar sensor, a lidar sensor, an ultrasonic sensor, and/or the like may be used as the environment sensor. The environment data in this case may be, for example, in the form of image data, scatter plots, and/or object lists. The environment data in this case may always describe an environment of the vehicle. In particular, the environment data may describe the environment of the vehicle in which the trailer is located. The environment data may then be used to acquire selected parameters of the trailer.

Furthermore, it is also conceivable for the at least one environment sensor, for example, in the form of at least one ultrasonic sensor or a camera, to be arranged on the trailer and to transmit the environment data by radio or cable connection. The at least one environment sensor may also be part of an infrastructure system. For example, such an infrastructure system may be a parking or traffic monitoring system. Familiar keywords in this context are so-called automated valet parking systems and so-called smart city systems.

For example, image data and/or lidar data in the form of scatter plots may be used to determine the trailer longitudinal axis. Furthermore, these data may also be used to identify and describe the trailer coupling-unit position of the trailer coupling of the trailer. The trailer longitudinal axis and, in particular, the trailer coupling-unit position may be used to describe the relative position of the vehicle with respect to the trailer. Conversely, the relative position of the trailer with respect to the vehicle, or to the vehicle longitudinal axis and the vehicle coupling unit of the trailer coupling of the vehicle, may of course also be determined.

The attitude of the vehicle may be determined for the purpose of describing the relative position of the vehicle with respect to the trailer. The environment data and/or the previously determined parameters of the trailer may be used for this purpose. In other words, the trailer coupling-unit position, or the position of the trailer and the orientation of the trailer longitudinal axis are known. Furthermore, the relative position, or orientation of the vehicle longitudinal axis with respect to the trailer longitudinal axis is known. And finally, the position of the vehicle, or the position of the vehicle coupling unit, in the form of the starting point relative to the trailer coupling-unit position, is known. It is additionally conceivable for the starting point to describe the position of the vehicle coupling unit only indirectly. For example, if the starting point describes the position of the center of gravity of the vehicle, and the position of the vehicle coupling unit relative to the center of gravity of the vehicle is known, the starting point thus also describes the position of the vehicle coupling unit, albeit only indirectly.

If the driver of the vehicle now wishes to be assisted during the process of coupling the vehicle to the trailer, the driver of the vehicle may indicate this wish via a system input. The system input in this case may be effected via a human-machine interface. Such a human-machine interface may be a (classic) operator-controlled element, a gesture control, a voice control, a touch screen, or the like. A trajectory for the vehicle may be planned based on the previously determined parameters of the trailer, in particular, of the trailer longitudinal axis and the trailer coupling-unit position, as well as the attitude of the vehicle, in particular, of the vehicle longitudinal axis and the starting point of the vehicle. The trajectory may commence at the starting point and end at a point, such that the vehicle coupling unit of the trailer coupling of the vehicle is within a tolerance range around the trailer coupling-unit position. In other words, the trajectory ends at a point at which the trailer can be coupled directly to the vehicle. The coupling may be effected either manually or in a partially automated manner, or also in an automated manner.

The trajectory is additionally characterized by the system input. As part of the system input, for example the coupling angle, between the vehicle longitudinal axis and the trailer longitudinal axis, at which the driver of the vehicle wishes to couple the trailer to the vehicle, may be input explicitly. Alternatively or additionally, it is conceivable for the coupling angle to be determined in dependence on the system input. If, for example, there is sufficient space to position the vehicle, such as, for example, in an open area or a large parking lot, the driver of the vehicle may want to maneuver the vehicle as quickly as possible into a position in which the trailer can be coupled to the vehicle. In such a case, the explicit input of a coupling angle is therefore not necessarily advantageous. Instead, the coupling angle may be determined by the trajectory having as few changes of direction as possible during maneuvering. Furthermore, it is also conceivable for the driver to maneuver the vehicle manually into an area close to the trailer and to specify the coupling angle via the attitude into which the driver has manually maneuvered the vehicle. In other words, the driver of the vehicle specifies the coupling angle via the orientation of the vehicle longitudinal axis relative to the trailer longitudinal axis.

In the two examples cited above, in which the explicit input of the coupling angle is not necessary, it is also conceivable for the coupling angle, which may be determined on the basis of the orientation of the vehicle longitudinal axis based on manual maneuvering or a wanted fastest possible coupling process, to be proposed to the driver and for the system input consequently nevertheless to include (albeit indirectly) an explicit input of the coupling angle.

Irrespective of whether the system input includes an explicit input of the coupling angle or the implicit input of a coupling angle, i.e., the coupling angle is determined in dependence on the system input, the trajectory is also determined by the vehicle longitudinal axis being at the coupling angle with respect to the trailer longitudinal axis following any maneuvering of the vehicle along the trajectory.

Furthermore, the order of the method steps is irrelevant. For example, it is conceivable for the trajectory to be planned once the system input has been effected by the driver. However, it is also conceivable for a plurality of trajectories to be planned first for different coupling angles, and for the driver of the vehicle to indirectly select a trajectory by selecting the coupling angle, or for the trajectory that best matches the system input to be used as the basis for the coupling process.

It is also advantageous if a maximum coupling angle range is determined, from which the coupling angle can be selected via the human-machine interfaces as part of the explicit input by the driver. The maximum coupling angle range in this case is the angle range in which the trailer can be coupled to the vehicle. The maximum coupling angle range therefore indicates the coupling angle at which the vehicle longitudinal axis and the trailer longitudinal axis can be orientated when the trailer is being coupled to the vehicle.

If, for example, a coupling angle of 0° is used in the case of a vehicle longitudinal axis orientated parallel to the trailer longitudinal axis, a maximum coupling angle range may be described, for example, by an interval of −60° to +60°. The maximum coupling angle range may be determined via the environment data and/or in consideration of the parameters of the trailer. This maximum coupling angle range may be displayed, or communicated, to the driver of the vehicle via the human-machine interfaces and/or an additional screen, a voice output, and/or the like. In particular, the driver or a user of the vehicle may explicitly input, i.e., select, the coupling angle from the maximum coupling angle range via the human-machine interfaces as part of the system input.

However, a coupling angle that is within the maximum coupling angle range may also be proactively proposed to the driver of the vehicle. Such a proactive proposal may be based on the current attitude of the vehicle and/or on a trajectory that serves to couple the trailer to the vehicle as quickly as possible.

In an advantageous design, the maximum coupling angle range is determined such that a predetermined minimum distance is maintained between the vehicle and a trailer body of the trailer. For example, it may be advantageous if the driver of the vehicle or another person can move between the trailer and the vehicle while the trailer is being coupled to the vehicle. If the vehicle is maneuvered along the planned trajectory and the vehicle coupling unit of the vehicle is within the tolerance range around the trailer coupling-unit position, the driver of the vehicle usually gets out and couples the trailer to the vehicle. In order to avoid having to walk an unnecessary distance around the vehicle and/or around the trailer, it may be advantageous if a predetermined minimum distance is maintained between the vehicle and the trailer body of the trailer.

The trailer body of the trailer may be described, for example, by the parameters of the trailer. Alternatively, the trailer body of the trailer may also be identified and described via the environment data. Furthermore, the length of the trailer coupling of the trailer may be described via the parameters of the trailer or the environment data. The closer the trailer coupling unit of the trailer coupling of the trailer is positioned to the trailer body, the smaller the maximum coupling angle range can be. If a maximum coupling angle range is now determined such that, in the case of a maximum coupling angle, the trailer body of the trailer and the vehicle are almost touching, or are only a few centimeters apart, for example less than 10 cm, the driver of the vehicle may have to walk around the vehicle or the trailer in order to couple the trailer to the vehicle. However, if a predetermined minimum distance is maintained, the maximum coupling angle range may be restricted. If the maximum coupling angle range is described by the interval from −60° to +60°, as in the example mentioned above, the maximum coupling angle range may be limited, for example, to an interval of −45° to +45°, due to a predetermined minimum distance.

Additionally, it is particularly advantageous if the predetermined minimum distance between the vehicle and the trailer body can be specified by the driver. The driver of the vehicle may therefore specify a predetermined minimum distance of, for example, one meter. By specifying the predetermined minimum distance between the vehicle and the trailer body in this way, the maximum coupling angle range may be restricted. The extent to which the maximum coupling angle range may be restricted in this case also depends on the parameters of the trailer. In particular, such a restriction may also depend on the distance between the trailer coupling unit of the trailer coupling of the trailer and the trailer body of the trailer. The specification of the predetermined minimum distance by the driver may be effected, for example, via the man-machine interfaces. In particular, this may be effected in a menu of the vehicle.

An advantageous design provides that the driver can select, from the maximum coupling angle range, only those coupling angles at which a predetermined maximum number of changes of direction of travel is not exceeded during maneuvering of the vehicle along the trajectory. Due to the environment of the vehicle, the attitude of the vehicle and/or due to the orientation of the trailer longitudinal axis and the trailer coupling-unit position, it may happen that particular coupling angles require extensive positioning during maneuvering of the vehicle along the trajectory. Such positioning may result in numerous changes of direction, or gear changes (change between forward and reverse gear). Positioning of the vehicle involving numerous changes of direction may be perceived by the driver, and by other passengers, and/or passers-by, as disruptive and/or awkward. It may therefore be advantageous if the driver of the vehicle can select only those coupling angles at which the predetermined maximum number of changes of direction is not exceeded. The predetermined maximum number of changes of direction may also be specified by the driver in a menu of the vehicle, via the human-machine interfaces.

Furthermore, it is advantageous if the driver can select, from the maximum coupling angle range, only those coupling angles at which collision-free maneuvering of the vehicle along the trajectory is possible, wherein an assessment of collision-free maneuvering is based on the environment data. The environment of the vehicle may be described via the received environment data. On the one hand, the environment data may be used for identifying the trailer and its parameters and, on the other hand, other objects, such as, for example, vehicles, obstacles, traffic signs, road signs, and/or the like, may be identified. Such an environment model, i.e., the description of the environment of the vehicle via the environment data, may be used to plan the trajectory. It may happen that particular trajectories, which irrespective of any obstacles are in principle suitable for maneuvering the vehicle into a coupling position and coupling the trailer to the vehicle at the coupling angle, nevertheless cannot be driven through without collision due to other objects in the vicinity of the vehicle.

If the trailer is parked, for example, on the shoulder or verge, and there is another vehicle in front of the trailer in the direction of towing, with only a gap of, for example, 3 meters in front of the trailer, the trailer may only be coupled to the vehicle in an angle range of, for example, 30° to 60°. Nevertheless, the maximum coupling angle range that would theoretically be possible if there were no obstacles, may be between −60° and 60°. In such a case, it is therefore advantageous if the driver of the vehicle can only select the range in which collision-free maneuvering of the vehicle along the trajectory is possible, i.e. the range from 30° to 60°.

Additionally, it is advantageous if the coupling angle, insofar as this is determined in dependence on the system input, is determined in such a way that the number of changes of direction during an at least partially automated maneuvering is minimal. In other words, if the driver of the vehicle simply wants to couple the trailer to the vehicle as quickly as possible, it may be advantageous for the coupling angle to be determined in such a way that as few changes of direction, or gear changes, as possible have to be performed. The number of changes of direction may therefore be minimized in determination of the coupling angle. As a result, during an at least partially automated maneuvering, the vehicle may be maneuvered to the trailer in one or a few moves, for example, such that the trailer can then be coupled directly to the vehicle.

Finally, it is also advantageous if the coupling angle, insofar as this is determined in dependence on the system input, is predefined by the angle of the vehicle longitudinal axis relative to the trailer longitudinal axis, which is calculated based on the attitude of the vehicle and on the parameters of the trailer. In other words, it may be advantageous if, for example, the driver maneuvers the vehicle manually into an area around the trailer, brings it to a standstill and the current orientation of the vehicle relative to the orientation of the trailer implicitly determines the coupling angle, i.e., based on the current attitude. The trajectory for the vehicle may then be planned such that the vehicle as a whole is only shifted laterally and/or longitudinally, but the angle between the vehicle longitudinal axis and the trailer longitudinal axis does not substantially change. In this way, what is wanted by the driver can be easily taken into consideration and the coupling maneuver can be performed extremely quickly.

A computing device according to the disclosure is configured to perform a method according to the disclosure and advantageous designs thereof. The computing device in this case may preferably comprise one or more programmable processors, which execute a program code of a computer program loaded in its working memory.

An assistance system according to the disclosure for a vehicle is configured to perform a method according to the disclosure and the advantageous designs thereof. The assistance system may have at least one environment sensor via which environment data describing the environment of the vehicle can be provided. Furthermore, the assistance system may have a computing device according to the disclosure, which may be formed, for example, by at least one electronic control device. The assistance system may also be designed to maneuver the vehicle in an at least partially automated manner. Such at least partially automated maneuvering may be effected along a planned trajectory.

In the context of the document, the term “at least partially automated” driving, or maneuvering, is understood to mean driving, or maneuvering, with automated lateral and/or longitudinal guidance. The term “at least partially automated” driving, or maneuvering, includes automated driving with any level of automation. Examples of levels of automation are assisted, partially automated, highly automated, fully automated, and autonomous driving (with increasing levels of automation in each case).

A further aspect of the disclosure relates to a computer program comprising instructions which, when the program is executed by a computing device, cause the computing device to perform a method according to the disclosure and the advantageous designs thereof. Furthermore, the disclosure relates to a computer-readable (memory) medium comprising instructions which, when executed by a computing device, cause the computing device to perform a method according to the disclosure and the advantageous designs thereof.

A vehicle according to the disclosure comprises an assistance system according to the disclosure. The vehicle may be realized, for example, as a truck, commercial vehicle, self-propelled work machine, mobile home, or the like. In particular, the vehicle may also be a passenger car.

The preferred embodiments presented in relation to the method according to the disclosure and their advantages apply correspondingly to the computing device according to the disclosure, to the assistance system according to the disclosure, to the vehicle according to the disclosure, to the computer program according to the disclosure and to the computer-readable (memory) medium according to the disclosure.

Further features of the disclosure are given by the claims, the figures and the description of the figures. The aforementioned features and combinations of features mentioned in the description, as well as the features and combinations of features mentioned below in the description of the figures and/or shown alone in the figures, can be used not only in the respective combination indicated, but also in other combinations or on their own, without departure from the scope of the disclosure.

### BRIEF DESCRIPTION OF THE DRAWINGS

The disclosure is now described more fully on the basis of preferred exemplary embodiments and with reference to the appended drawings.

FIG. 1 shows a schematic representation of a vehicle that has an assistance system for assisting a driver during a coupling process;

FIG. 2 shows a schematic representation of a vehicle and of a trailer that can be coupled to the vehicle;

FIG. 3 shows a schematic representation of a human-machine interface that is configured to detect a system input by a driver;

FIG. 4 shows a schematic representation of the vehicle and of the trailer according to FIG. 2, with an addition representation of a trajectory along which the vehicle can be maneuvered during a coupling process;

FIG. 5 shows a schematic representation of the vehicle and of the trailer according to FIG. 2, the vehicle having been maneuvered along the trajectory according to FIG. 4, and the trailer coupled to the vehicle;

FIG. 6 shows a schematic representation of the vehicle and of the trailer, the coupling angle being implicitly specified by the starting position of the vehicle, or in dependence on the system input;

FIG. 7 shows a representation of the vehicle and of the trailer, the coupling angle being implicitly specified by the trailer being able to be coupled to the vehicle as quickly as possible;

FIG. 8 shows a schematic representation of a vehicle and of a trailer that is parked on a shoulder or verge of a roadway, thereby restricting a maximum coupling angle range;

FIG. 9 shows a schematic representation of the vehicle and of the trailer, according to FIG. 8, with the maximum coupling angle range being additionally restricted due to another road user; and

FIG. 10 shows a schematic representation of a human-machine interface, the maximum coupling angle range that can be selected by the driver being restricted due to the situation according to FIG. 9.

In the figures, elements that are the same or functionally the same are denoted by the same reference designations.

### DETAILED DESCRIPTION OF THE DRAWINGS

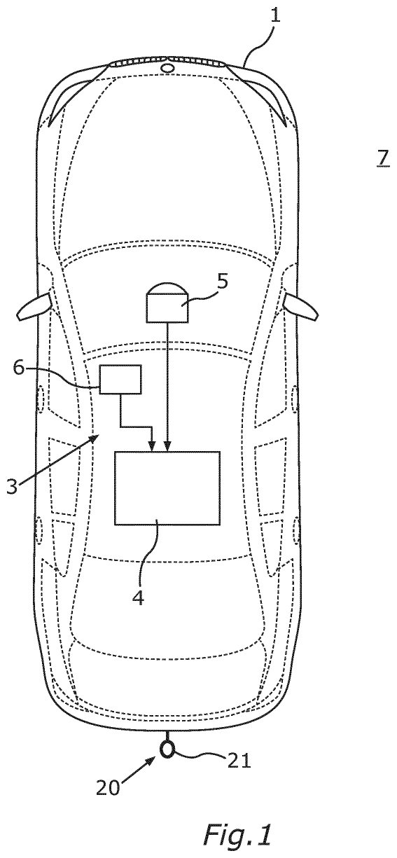

FIG. 1 shows a schematic representation of a vehicle 1 that has a trailer coupling 20. The trailer coupling 20 additionally has a vehicle coupling unit 21, represented in the form of a coupling ball. The vehicle 1 has an assistance system 3. The assistance system 3 is configured to assist a driver of the vehicle 1 in the process of coupling the vehicle 1 to a trailer 2. The assistance system 3 comprises a computing device 4, which is configured, inter alia, to receive environment data from at least one environment sensor 5 of the vehicle 1. The computing device 4 may also acquire a system input from the driver via a human-machine interface 6.

In particular, the vehicle 1 may be a passenger car. Furthermore, however, the vehicle 1 may generally also be a truck, a commercial vehicle, a self-propelled work machine, a mobile home, or the like. In particular, the vehicle 1 may also be a tractor, an agricultural or forestry tractor unit, an articulated truck, or the like.

In FIG. 1 the environment sensor 5 is represented as a camera. Equally, a radar, lidar, and/or ultrasonic sensor may be used as the environment sensor 5. The environment sensor 5 provides, or the environment sensors 5 provide environment data describing an environment 7 of the vehicle 1 to the computing device 4. Typically, a plurality of environment sensors 5 are used for this purpose. The representation of a single environment sensor 5 in FIG. 1 is for clarity. It is therefore conceivable, in particular, for a plurality of environment sensors 5 and also a wide variety of sensor types to be used.

The human-machine interface 6 may be, for example, a touch screen. The human-machine interface 6 may equally be a display including classic operator-controlled elements such as, for example, push buttons, dials, and/or switches. Additionally, head-up displays in combination with operator-controlled elements, voice control, or the like, are also conceivable. The human-machine interface 6 serves to acquire a request by the driver for assistance in coupling the trailer 2 to the vehicle 1

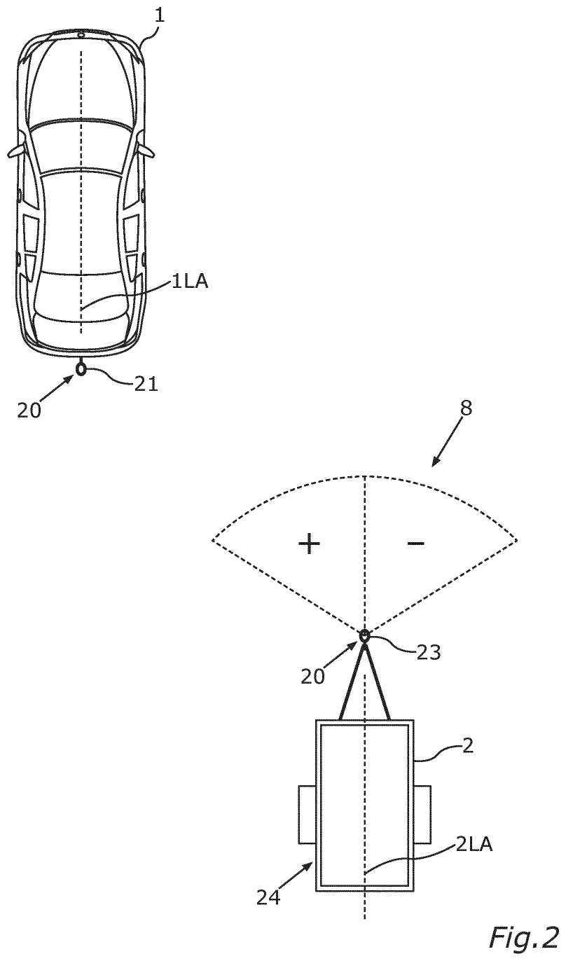

FIG. 2 shows a schematic representation of the vehicle 1 and of a trailer 2 that is to be coupled to the vehicle 1. Also shown in the schematic representation are the vehicle longitudinal axis 1LA and the trailer longitudinal axis 2LA. Additionally, a maximum coupling angle range 8 is indicated. In this example, the maximum coupling angle range extends approximately from −60° to +60°. The positive angle range of the maximum coupling angle range 8 is denoted by a plus sign. The negative angle range of the maximum coupling angle range 8 is denoted by a minus sign.

In FIG. 2 the trailer 2 is represented as a simple single-axle car trailer. However, the trailer may equally be a caravan, horse trailer, semi-trailer, or similar. In this example, it is an unsteered trailer. It is also conceivable, however, for the trailer to have swivel-axis steering, or single-pivot steering.

The trailer 2 additionally has a trailer coupling 20. The trailer coupling 20 comprises a trailer coupling unit 23, represented in the form of a tow-ball coupling. The trailer 2 also comprises a trailer body 24.

The trailer coupling unit 23 and the vehicle coupling unit 21 together are two devices that act mechanically in combination and that are configured to connect the vehicle 1 to the trailer 2. Depending on the type of vehicle 1 and trailer 2, the trailer coupling unit 23 and the vehicle coupling unit 21 may also be corresponding coupling parts of a pin coupling, a jaw coupling, or a fifth-wheel coupling. In these figures, the examples are corresponding coupling parts of a ball coupling that correspond to the current coupling standard, especially in the passenger car sector, in combination with light trailers (with/without overrun brake)—as represented in the these figures.

Parameters of the trailer 2 may be acquired via the environment data of the at least one environment sensor 5 of the vehicle 1. These parameters describe at least the trailer longitudinal axis 2LA and the trailer coupling-unit position, i.e., the position of the trailer coupling unit 23. Based on this, an attitude of the vehicle 1, which describes the position of the vehicle 1 relative to the position of the trailer coupling unit 23, can be determined. The attitude of the vehicle 1 is also determined via the environment data of the environment sensor 5 and/or in consideration of the parameters of the trailer 2. Of particular importance here is the position of the vehicle coupling unit 21 of the trailer coupling 20 of the vehicle 1 and the vehicle longitudinal axis 1LA.

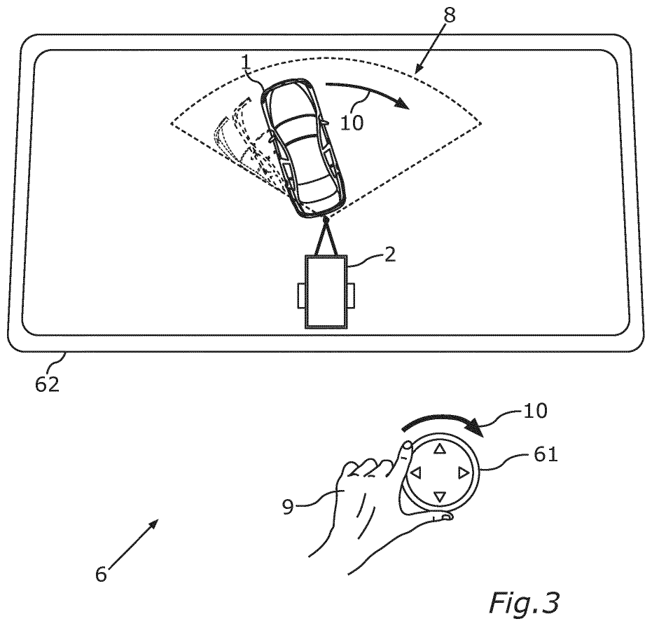

FIG. 3 shows a schematic representation of a human-machine interface 6 that is configured to acquire the system input of the driver of the vehicle 1. The human-machine interface 6 comprises a display 62 and an operator-controlled element 61 via which the driver of the vehicle 1 and/or a user of the vehicle may interact via a hand 9. In this example, the trailer 2 detected via the environment data is shown on the display 62. In addition, a maximum coupling angle range 8 may be shown in the display 62. Additionally, it is conceivable for the vehicle 1 to be also visualized on the display 62. The driver of the vehicle 1 may use a hand 9 and the operator controlled element 61 to select a coupling angle φ from the maximum coupling angle range 8 via rotation, which is represented by the arrow 10. Additionally, it is conceivable for the currently selected coupling angle φ to be highlighted in the display 62. If the driver or a user of the vehicle 1 turns the operator-controlled element 61 using a hand 9, it is conceivable for the vehicle 1 to be rotated on the display 62 within the maximum coupling angle range 8 around the trailer coupling unit 23 of the trailer coupling 20 of the trailer 2. This movement is indicated in FIG. 3 by a further arrow 10. It is also conceivable for the representation of the vehicle 1 and of the trailer 2 in the display 62 to be combined with, or superimposed by, a 360° all-round view of the vehicle 1 and/or of the trailer 2.

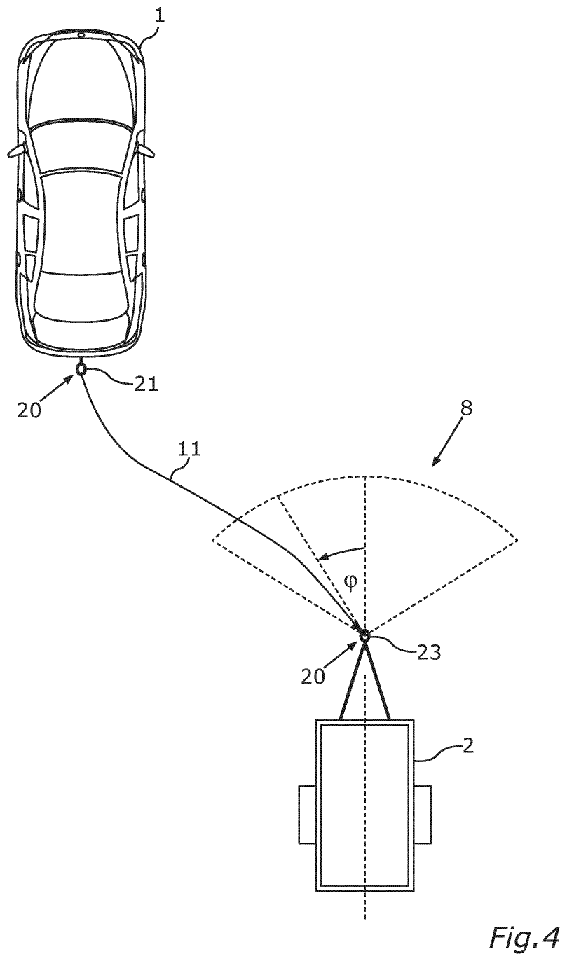

FIG. 4 shows a schematic representation of the vehicle 1 and of the trailer 2 as shown in FIG. 2, with an additional trajectory 11 being indicated. Based on the system input, which in this case is represented by an explicit input of the coupling angle φ as part of the system input, a trajectory 11 may be planned, or selected. The vehicle 1 may then be maneuvered, in an at least partially automated manner, along the trajectory 11 by the assistance system 3. The trajectory 11 commences at a starting point and is determined by the vehicle coupling unit 21 of the trailer coupling 20 of the vehicle 1 being located in a tolerance range around the position of the trailer coupling unit 23 of the trailer coupling 20 of the trailer 2, following the at least partially automated maneuvering of the vehicle 1 along the trajectory 11.

The assistance system 3 of the vehicle 1 in this case may be designed such that, for example, the lateral guidance of the vehicle 1 is taken over by the assistance system 3. However, it is also conceivable for the assistance system 3 to take over the longitudinal and lateral guidance of the vehicle 1. The tolerance range around the position of the trailer coupling unit 23 of the trailer coupling 20 of the trailer 2 may be predetermined. Ideally, if the external conditions allow it, the vehicle coupling unit 21 of the trailer coupling 20 of the vehicle 1 comes to a standstill exactly in the trailer coupling unit position. For example, in the case of a ball coupling, a possibly optional adaptive chassis of the vehicle 1 may also be used for this purpose. For example, the vehicle 1 may be lowered via such an adaptive chassis, such that the vehicle coupling unit 21, in this case the coupling ball, can be positioned directly beneath the trailer coupling unit 23, i.e., the-tow ball coupling.

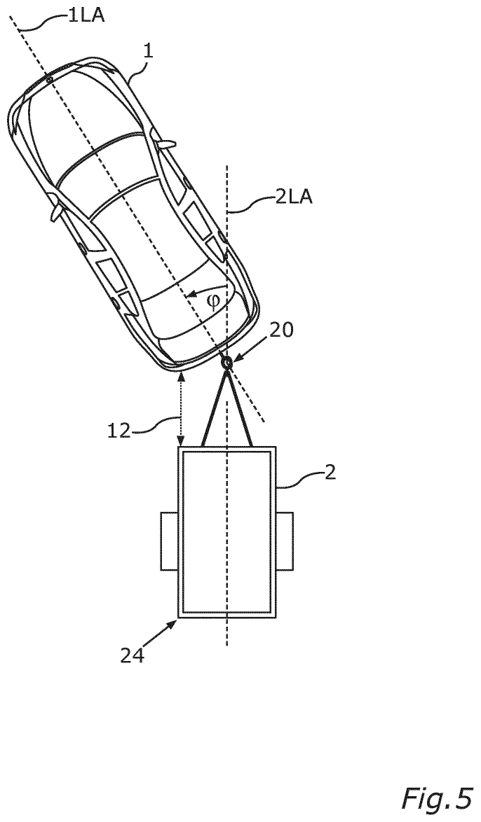

Following the maneuvering of the vehicle 1 along the trajectory 11, the vehicle 1 is positioned in such a way that the vehicle longitudinal axis 1LA is oriented at the coupling angle φ in relation to the trailer longitudinal axis 2LA. This situation is represented again in FIG. 5. Furthermore, the distance between the vehicle 1 and the trailer body 24 is also represented in FIG. 5. This distance 12 may also be specified by the driver, for example, in the form of a predetermined minimum distance between the vehicle 1 and the trailer body 24. Such a specification of a predetermined minimum distance may restrict a maximum coupling angle range 8. This is relevant, in particular, if the distance between the trailer body 24 and the trailer coupling unit 23 is small. In such a case and with a large coupling angle φ, this may result in the driver of the vehicle 1, in order to couple the trailer 2 to the vehicle 1, having to walk around the vehicle 1 or around the trailer 2 in order to reach the trailer coupling 20 of the vehicle 1, or of the trailer 2.

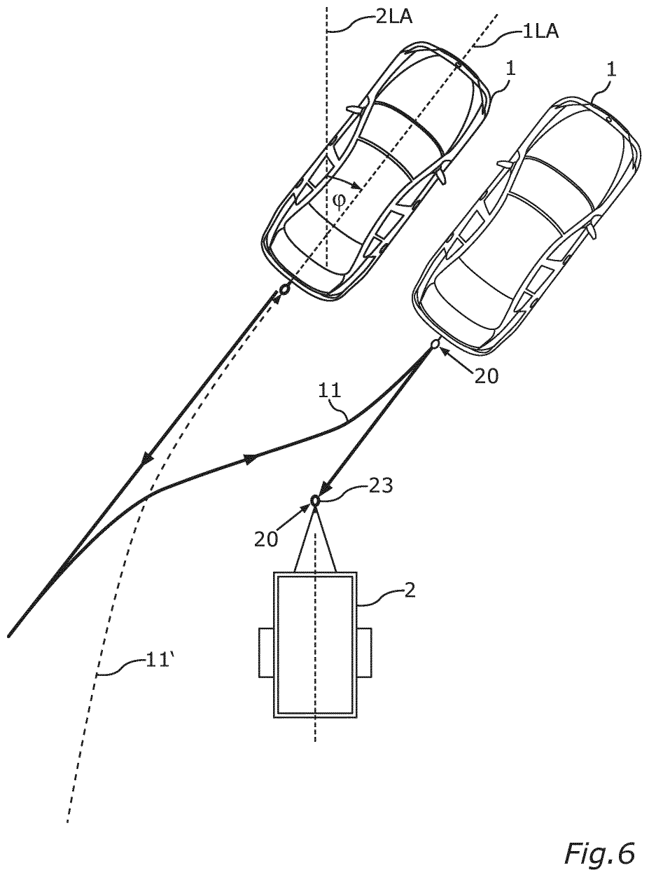

FIG. 6 shows a schematic representation of the vehicle 1 and the of trailer 2, with the coupling angle φ being determined in dependence on the system input. In other words, an implicit input of the coupling angle φ is effected by the vehicle 1 being manually maneuvered along the (dashed) trajectory 11′ by the driver of the vehicle 1, and the driver of the vehicle 1 requesting assistance in the coupling process at the end of the trajectory 11′, whereby the vehicle 1 in the coupled state is to be oriented in the same way as it is oriented at the end of the trajectory 11′.

In other words, the angle between the vehicle longitudinal axis 1LA and the trailer longitudinal axis 2LA at the end of the trajectory 11′ corresponds to the coupling angle φ. In this example, the at least partially automated maneuvering of the vehicle 1 toward the trailer 2 may be realized by the vehicle 1 first being reversed by the assistance system 3 along the trajectory 11, then moving forward, coming to a standstill parallel to the initial position and then reversing straight back until the vehicle coupling unit 21 of the trailer coupling 20 of the vehicle 1, i.e., in this case the coupling ball, is directly under the trailer coupling unit 23 of the trailer coupling 20 of the trailer 2, or is positioned within a tolerance range around the trailer coupling unit 23 of the trailer coupling 20 of trailer 2, i.e., the tow-ball coupling. Finally, the vehicle 1 is positioned in such a way that the trailer 2 can be coupled to the vehicle 1 and additionally the vehicle longitudinal axis 1LA is at a coupling angle φ in relation to the trailer longitudinal axis 2LA.

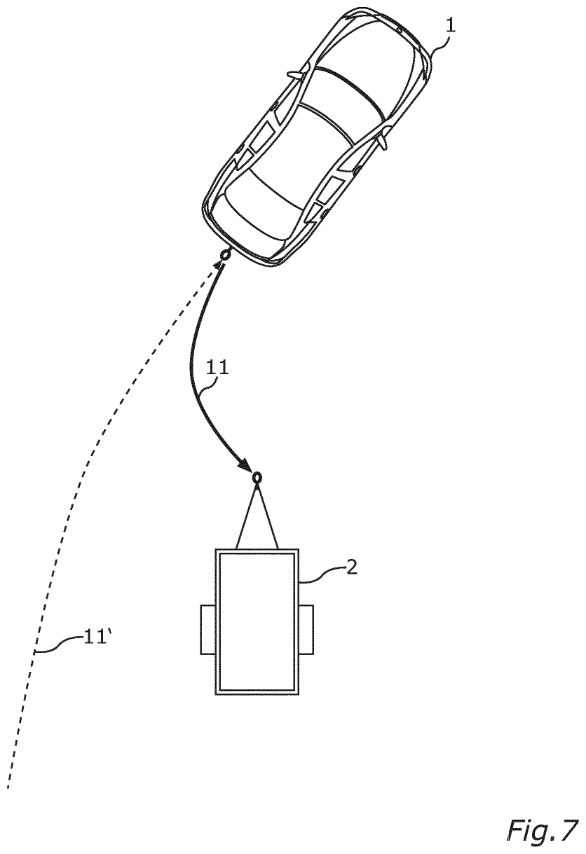

FIG. 7 shows a schematic representation of the vehicle 1 and of the trailer 2, with the coupling angle φ being again determined in dependence on the system input (as already represented in FIG. 6). In other words, an implicit input of the coupling angle φ is effected by the vehicle 1 being manually maneuvered along the (dashed) trajectory 11′ by the driver of the vehicle 1, and the driver of the vehicle 1 requesting assistance with the coupling process at the end of the trajectory 11′, whereby the vehicle 1 is to be maneuvered as quickly as possible into a position in which the trailer 2 can be coupled to the vehicle 1.

The driver's request for assistance in coupling the trailer 2 to the vehicle 1 as quickly as possible thus determines the coupling angle φ in dependence on the system input. In this context, as quickly as possible may mean that the maneuvering of the vehicle 1 along the trajectory 11 by the assistance system 3 involves, or requires, as few changes of direction, as short a distance, or as short a duration as possible.

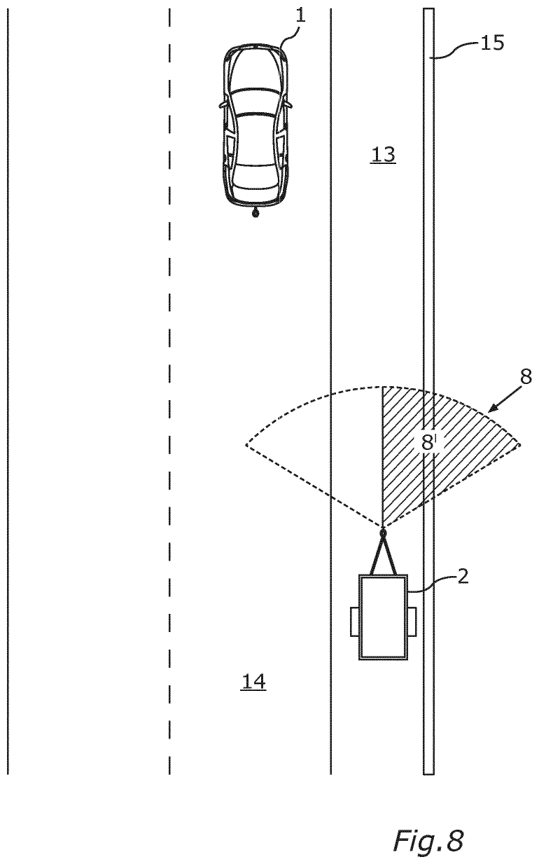

FIG. 8 shows a schematic representation of the vehicle 1 and of the trailer 2, which is parked on a shoulder or verge 13 of a roadway 14. If, in this situation, the driver of the vehicle 1 wishes to be assisted in coupling the trailer 2 to the vehicle 1, or in positioning the vehicle 1 so that the trailer 2 can be coupled to the vehicle 1, the maximum coupling angle range 8 is restricted due to the curb 15. This restriction is indicated in FIG. 8 by the hatched area 8′. In other words, from the maximum coupling angle range 8, the driver of the vehicle 1 can only select the coupling angle φ at which collision-free maneuvering of the vehicle 1 along a correspondingly planned trajectory 11 is possible. The assessment of the collision-free maneuvering may be effected, for example, via the environment data of the at least one environment sensor 5.

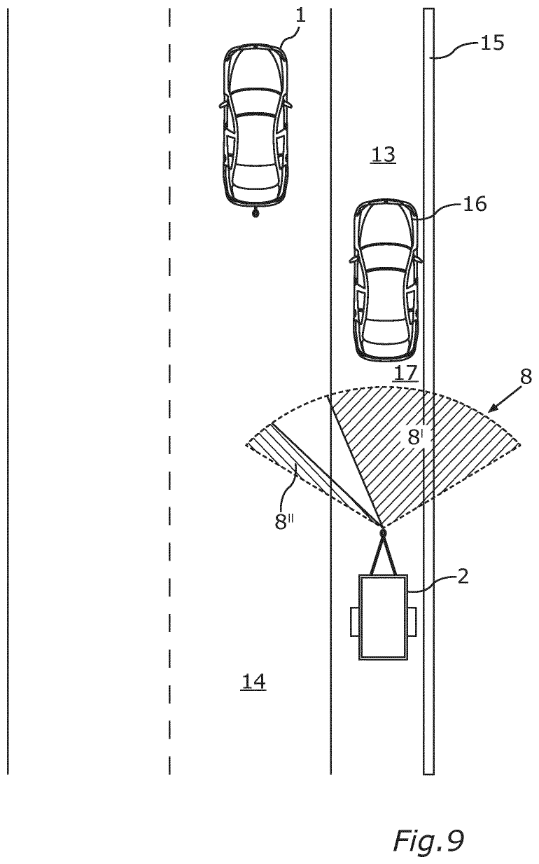

FIG. 9 shows a schematic representation of the vehicle 1 and of the trailer 2, which is parked on a shoulder or verge 13 of a roadway 14. A similar situation is already disclosed and described in detail in FIG. 8. In contrast to FIG. 8, however, another road user 16, represented by a passenger car, is also located on the shoulder or verge 13. The parking space 17, i.e., the area between the other road user 16 and the trailer 2, may be so short that a not inconsiderable number of changes of direction, for example three or more, would be necessary to maneuver the vehicle in the longitudinal direction into the parking space 17 and to couple the trailer 2 to the vehicle 1 at a coupling angle φ of 0°.

It may be advantageous in this context if a predetermined maximum number of changes of direction is specified, which may restrict the maximum coupling angle range 8. It is also conceivable, however, for the driver of the vehicle 1 to specify, in a menu of the vehicle, the predetermined maximum number of changes of direction. The resulting restriction is represented in FIG. 9 by the hatched angle range 8′ (on the right). A similar case arises if the parking space 17, or a free area in the towing direction in front of the trailer 2, is too short and a coupling angle φ of 0° cannot be realized as a result. In other words, a similar case thus arises if, for example, an obstacle or another road user 16 is positioned too close in front of the trailer 2 in the towing direction.

It is furthermore conceivable that a predetermined minimum distance is to be maintained between the vehicle 1 and the trailer body 24 of the trailer 2. Such a predetermined minimum distance may result in an additional restriction of the maximum coupling angle range 8. The additional restriction of the maximum coupling angle range 8 due to a predetermined minimum distance is indicated by the hatched area 8″ (on the left).

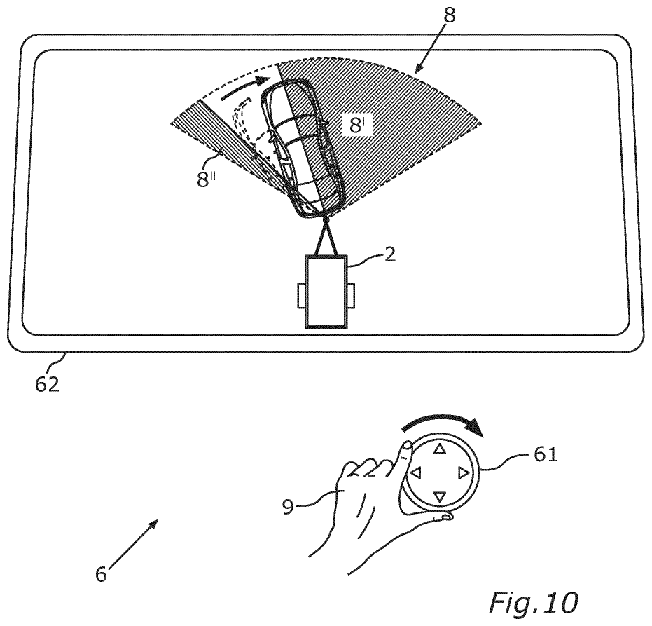

FIG. 10 shows a schematic representation of a possible form of the human-machine interface 6, and the representation on the display 62 is based on the traffic situation represented in FIG. 9. The driver of the vehicle 1 may use a hand 9 and the operator-controlled element 61 to select, from the maximum coupling angle range 8, only those coupling angles φ for which a trajectory 11 exists, or can be realized, such that, on the one hand, the predetermined maximum number of changes of direction of travel is not exceeded and, on the other hand, the predetermined minimum distance between the vehicle 1 and the trailer body 24 is ensured. In this exemplary embodiment, the non-selectable areas 8′ and 8″ are highlighted in grey on the display 62.

1.-13. (canceled)

14. A method for assisting an occupant of a vehicle in a process of coupling the vehicle to a trailer, comprising:
receiving environment data from at least one environment sensor,
acquiring parameters of the trailer via the environment data, wherein the parameters describe at least a trailer longitudinal axis and a trailer coupling-unit position of a trailer coupling unit of the trailer,
determining an attitude of the vehicle via the environment data and/or in consideration of the parameters of the trailer, wherein the attitude describes at least a starting point of the vehicle relative to the trailer coupling-unit position, and a vehicle longitudinal axis relative to the trailer longitudinal axis,
acquiring a system input from the occupant of the vehicle via a human-machine interface, wherein the system input describes a request for assistance to couple the trailer to the vehicle, and
planning a trajectory for the vehicle, wherein the trajectory commences at the starting point and is determined such that a vehicle coupling unit of the vehicle is in a tolerance range around the trailer coupling-unit position following maneuvering of the vehicle along the trajectory,
wherein the system input comprises an explicit input of a coupling angle between the vehicle longitudinal axis and the trailer longitudinal axis, and/or the coupling angle is determined in dependence on the system input, and
wherein the trajectory is additionally determined by the vehicle longitudinal axis, following maneuvering of the vehicle along the trajectory, being at the coupling angle in relation to the trailer longitudinal axis.

15. The method according to claim 14,
wherein a maximum coupling angle range is determined, from which the coupling angle can be selected via the human-machine interfaces as part of the explicit input.

16. The method according to claim 15,
wherein the maximum coupling angle range is determined such that a predetermined minimum distance is maintained between the vehicle and a trailer body of the trailer.

17. The method according to claim 16,
wherein the predetermined minimum distance between the vehicle and the trailer body can be specified by the occupant.

18. The method according to claim 15,
wherein the occupant can select, from the maximum coupling angle range, only those coupling angles at which a predetermined maximum number of changes of direction of travel is not exceeded during maneuvering of the vehicle along the trajectory.

19. The method according to claim 15,
wherein the occupant can select, from the maximum coupling angle range, only those coupling angles at which collision-free maneuvering of the vehicle along the trajectory is possible, wherein an assessment of collision-free maneuvering is based on the environment data.

20. The method according to claim 14,
wherein the coupling angle, when determined in dependence on the system input, is determined such that the number of changes of direction during an at least partially automated maneuvering is minimal.

21. The method according to claim 14,
wherein the coupling angle, when determined in dependence on the system input, is predefined by the angle of the vehicle longitudinal axis relative to the trailer longitudinal axis, which is calculated based on the attitude of the vehicle and on the parameters of the trailer.

22. A computing device configured to perform a method for assisting an occupant of a vehicle in a process of coupling the vehicle to a trailer, according to claim 14.

23. A computer program, comprising instructions that cause the computing device of claim 22 to perform the method according to claim 14.

24. A computer-readable (memory) medium, on which the computer program according to claim 23 is stored.

25. An assistance system for assisting an occupant of a vehicle in a process of coupling the vehicle to a trailer, comprising:
a computing device according to claim 22,
a human-machine interface for acquiring a system input from the occupant, wherein the system input describes a request from the occupant for assistance to couple the trailer to the vehicle, and
at least one environment sensor, which provides environment data that describe an environment of the vehicle.

26. A vehicle comprising an assistance system according to claim 25.
